(19) United States
(12) Patent Application Publication
(10) Pub. No.: US 2012/0086250 A1
(43) Pub. Date: Apr. 12, 2012

(54) Device and Method for Regulating a Lateral Part of a Seat

(75) Inventors: Veit Stoessel, Nurnberg (DE); Walter Schindlegger, Seitenstetten (AT)

(73) Assignee: SCHUKRA GERATEBAU AG, Berndorf (AT)

(21) Appl. No.: 11/910,697

(22) PCT Filed: Mar. 31, 2006
(86) PCT No.: PCT/EP2006/002983

§ 371 Date: Sep. 2, 2011

(30) Foreign Application Priority Data
Apr. 8, 2004 (DE) DE1020050164757
Mar. 31, 2006 (EP) PCT/EP2006/002983

(51) Int. Cl. B60N 2/64; A47C 7/46

(52) U.S. Cl. 297/284.9

(57) ABSTRACT

An adjusting device for adjusting a side cheek of a seat comprises a bending element (31) which is to be coupled to the side cheek and the curvature of which can be reversibly changed, and a holder with a base section (36) and a pivoting section (37) pivotably attached thereto. The adjusting device is designed in such a way that, when a force is exerted by means of an actuating device (21, 22), the bending element (31) is first displaced relative to the holder and then bent, so that a section (34) to be coupled to the side cheek executes a movement which runs first rectilinearly and then arcuately and which is transmitted to the side cheek of the seat.

The present invention relates to a device and to a method for adjusting a side cheek of a seat, in particular a motor vehicle seat, and to a corresponding seat.

Side cheeks are employed in a large number of motor vehicle seats, for example in sports seats, in order to provide a person sitting on a seat with additional lateral support. Particularly when travelling round a bend, inertial forces acting on the occupant of the seat are effectively absorbed by the side cheeks in order thus to prevent the person from moving laterally relative to the seat. For this purpose, side cheeks are preferably arranged on the lateral edges of a backrest of the respective seat in order to provide lateral supporting surfaces for the upper body of the person sitting on the seat. Many seat backrests, however, offer only very little lateral support, since vehicle seats are frequently designed so as to be suitable for vehicle occupants with different body sizes, and side cheeks are therefore frequently arranged far to the outside of the backrests.

In order to be able to adapt the side cheeks individually to the size of the particular person sitting on the seat, adjustable side cheeks have been developed. Various devices for adjusting side cheeks are known from the art, for example an electromechanical or a pneumatic adjusting device, as disclosed for example in DE 199 10 082 C1.

Adjusting devices for side cheeks known from the art have the problem that, particularly with adjustment by air cushions, it is rather the backrest contour that is altered than the backrest width that is adjusted. Moreover, conventional adjusting devices for seat cheeks frequently take up a relatively large amount of space. Particularly owing to the integration of an ever-increasing number of different functionalities in motor vehicle seats, there is an increasing need to reduce the space taken up by the individual devices to be accommodated in the seat. There is thus a need in the art for an adjusting device for a side cheek of a seat which has a compact design.

Furthermore, the side cheeks employed in known seats are frequently unsuitable for providing the driver with sufficient lateral support in the event of large lateral forces, for example when travelling round a bend at high speed.

The object of the present invention is therefore to provide an improved adjusting device for a side cheek of a seat, an improved method for adjusting a side cheek of a seat, and a seat having an improved side cheek adjusting device. In particular, it is an object to provide an adjusting device for a side cheek of a seat which has a flat design and preferably makes it possible to provide improved lateral support for a person sitting on the seat.

This object is achieved, according to the invention, by an adjusting device for a side cheek of a seat according to Claim 1 and a method for adjusting a side cheek of a seat according to Claim 20. The dependent claims define preferred or advantageous exemplary embodiments of the present invention.

An adjusting device according to the invention for a side cheek of a seat comprises a bending element to be coupled to the side cheek. The curvature of the bending element can be reversibly changed by exerting a force on the bending element in order to adjust the side cheek in dependence on the curvature of the bending element. To exert a force on the bending element, in use, the bending element is to be coupled to an actuating device. Since, in the adjusting device according to the invention, the side cheek is adjusted according to the curvature of the bending element, and since the bending element can have a low height in its rest configuration, the adjusting device according to the invention can have a low overall height, i.e. a flat design.

The bending element is preferably biased towards a rest configuration in which it has no curvature or little curvature. The bending element furthermore preferably is substantially flat in the rest configuration. Through such a configuration, the overall height of the adjusting device is reduced.

The bending element furthermore preferably comprises a plate made of resilient steel or is produced from plastic. As a result, it is possible to employ the elastic restoring force of the plate to bias the bending element towards a rest configuration which is flat or has a small curvature. Alternatively or additionally, a helical spring or a plurality of helical springs can be coupled to the bending element in order to increase the bias towards the rest configuration.

The adjusting device can comprise supporting means to which the bending element is displaceably attached. As a result, it is possible, by combining a displacement of the bending element along the supporting means with an alteration of the curvature of the bending element, to define a curve along which the side cheek is adjusted. In particular, in this case, the bending element can be coupled in use to the actuating device in such a way that, when a force is exerted on the bending element by the actuating device, the bending element is first displaced relative to the supporting means, so that the actuating device can be employed both to displace the bending element and to bend the bending element.

Stop means can be provided in order to prevent further displacement of the bending element relative to the supporting means as soon as the bending element has reached a preset position relative to the supporting means. In this case, the supporting means, the bending element and the stop means can be configured in such a way that a force exerted by the actuating device leads first to a displacement of the bending element relative to the supporting means up to the preset position, and a subsequently further exerted force alters the curvature of the bending element. Through this configuration of the adjusting device, it is possible to adjust the side cheek according to an adjusting curve which, starting from a surface of the seat, first has a substantially straight section and then a curved section.

If the bending element is displaceably attached to the supporting means, guide means can be provided to define the movement path of the bending element relative to the supporting means. In particular, the guide means can comprise a guide opening provided on the bending element, with which a guide projection provided on the supporting means engages. Alternatively, a guide opening can be provided on the supporting means, with which opening a guide projection provided on the bending element engages.

The supporting means preferably comprise a basis section and a pivoting section pivotably mounted thereon. The supporting means can in particular be configured in such a way that the pivoting section, when performing a pivoting movement relative to the basis section, contacts the bending element in order to transmit a force, acting on the pivoting section, to the bending element. This can be advantageous since the actuating device no longer exerts a locally large force directly on the bending element, but the force exerted by the actuating device is transmitted to the bending element via the pivoting section. As a result, the load occurring on the bending element can be reduced. The actuating device is preferably coupled in use to the pivoting section.

The adjusting device may comprise an actuating device which is coupled to the bending element in order to exert a force on the latter. In particular, the actuating device may comprise a Bowden control, the sheath or other end piece of which is coupled to the bending element and the cable of which is coupled to the supporting means. Through this configuration, it is possible in a simple manner to use the actuating device both to displace the bending element with respect to the supporting means and to bend it.

A seat according to the invention comprises an adjustable side cheek and an adjusting device, according to an exemplary embodiment of the invention, coupled to the latter. The seat preferably comprises two adjustable side cheeks, each of which is coupled to respectively one adjusting device according to an exemplary embodiment of the present invention. The adjustable side cheek is preferably arranged on a backrest of the seat. The seat furthermore preferably comprises an actuating device coupled to the adjusting device in order to exert a force on the latter. If the actuating device comprises a Bowden control, it is in particular possible to separate an actuator of the actuating device, for example an electric motor with a cable roller or cable pulley attached thereto, spatially from the adjusting device. This leads to greater flexibility with regard to accommodation of the actuator on or in the seat.

The actuating device can be activated by an occupant of the vehicle by actuation of a corresponding switch which is coupled to the actuating device. Alternatively or additionally, control means coupled to the actuating device and serving to control the actuating device, and a sensor or a plurality of sensors can be provided, the output of which is coupled to the control means. In particular, an acceleration sensor can be provided, the output signal of which represents an acceleration acting on the seat, so that the actuating device is controlled by the control means in dependence on the acceleration acting on the seat in order to correspondingly adjust the side cheek. Various other sensors can also be employed, for example sensors for detecting the opening of a vehicle door.

In the seat according to the invention, the adjusting device is preferably arranged on the seat and configured in such a way that the side cheek is adjusted according to an adjusting curve which, starting from a seat surface, first comprises a substantially straight section and then a curved section running inwards with respect to the seat. It is thus possible, so to speak, to embrace a person sitting on the seat from behind and provide the person with improved lateral support.

In a method according to the invention for adjusting a side cheek of a seat, the side cheek is adjusted according to an adjusting curve which, starting from a seat surface of the seat, first comprises a straight section and then a curved section running inwards with respect to the seat. In this case, the combination of straight section/curved section can in principle be freely selected. In the method according to the invention, the side cheek is preferably adjusted by an adjusting device according to the invention.

The present invention is mainly employed in vehicle seats, but is not restricted to these.

The present invention is explained in more detail below with the aid of preferred exemplary embodiments with reference to the appended drawing.

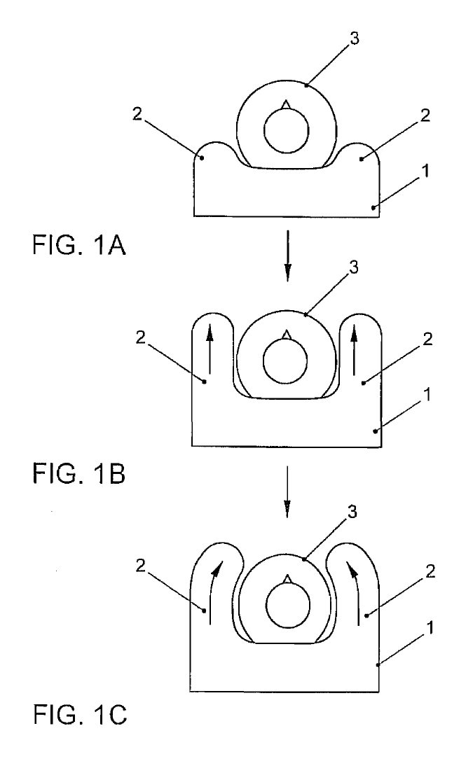

FIG. 1 illustrates schematically a method according to the invention for adjusting a side cheek of a seat.

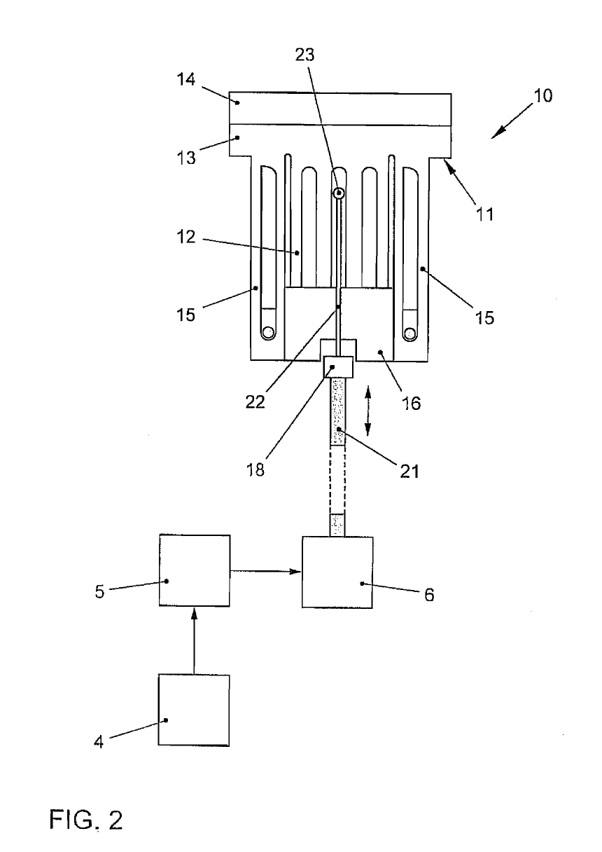

FIG. 2 shows schematically an adjusting device for a side cheek according to a first exemplary embodiment.

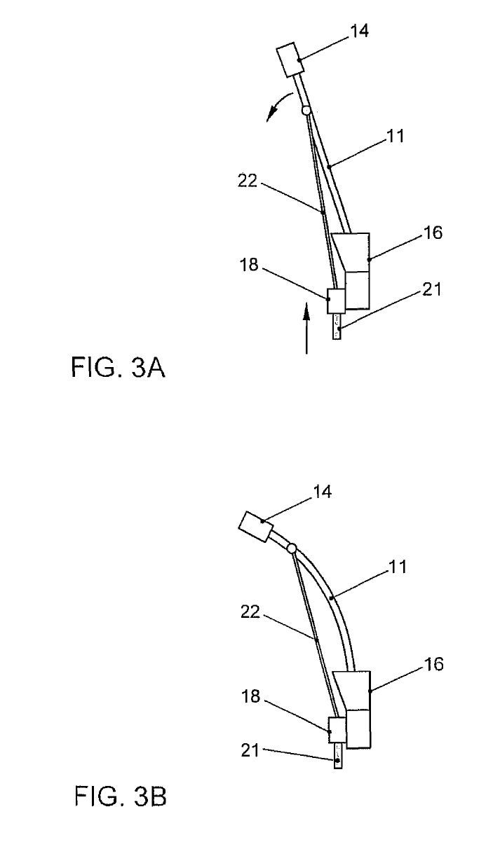

FIG. 3 shows schematically the adjusting device of FIG. 2 in a side view at different moments during its actuation.

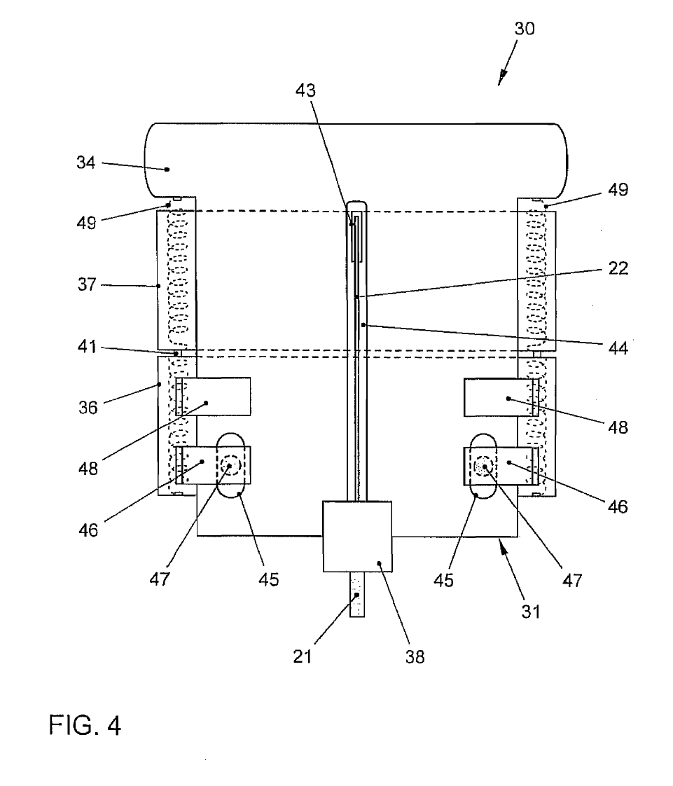

FIG. 4 shows schematically an adjusting device for a side cheek according to a second exemplary embodiment.

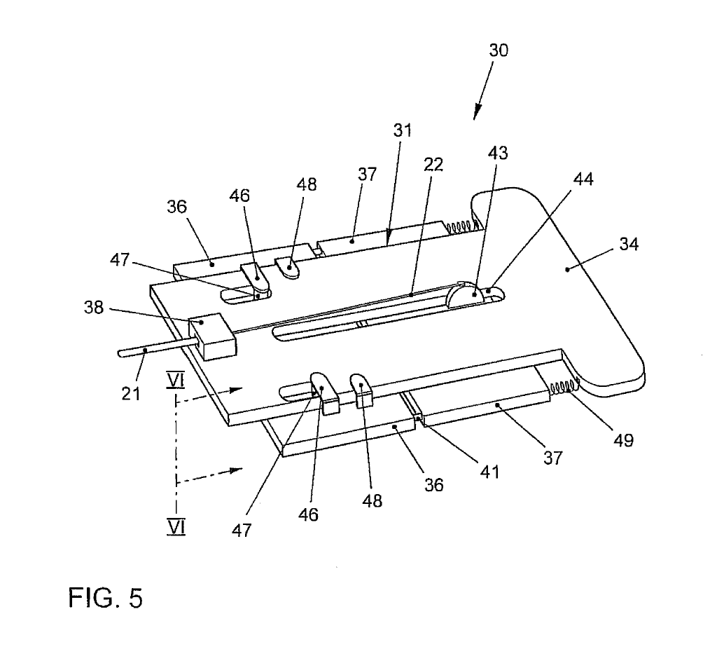

FIG. 5 is a perspective view of the adjusting device of FIG. 4.

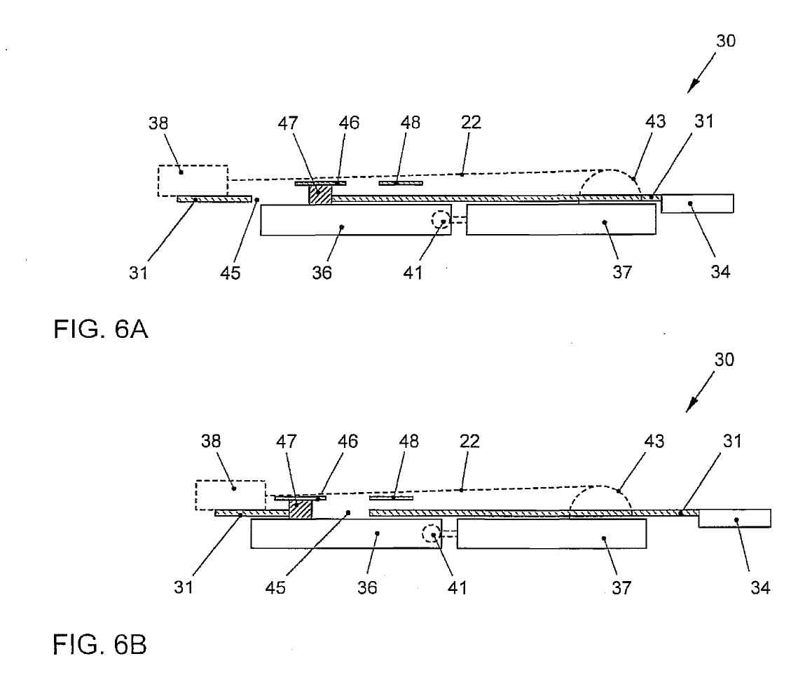

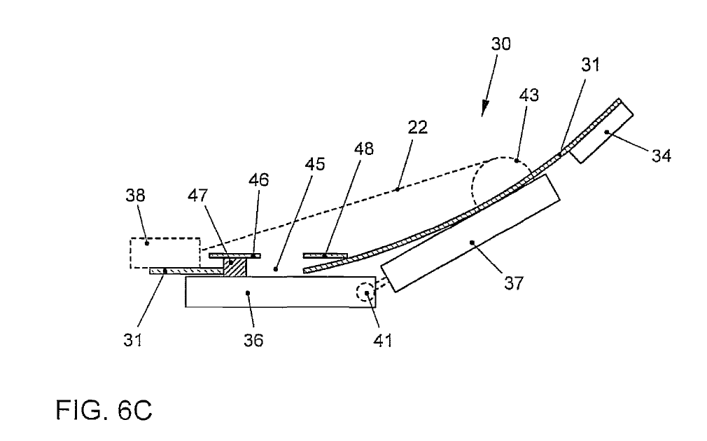

FIG. 6 shows schematically the adjusting device of FIG. 4 in a side view at different moments during its actuation.

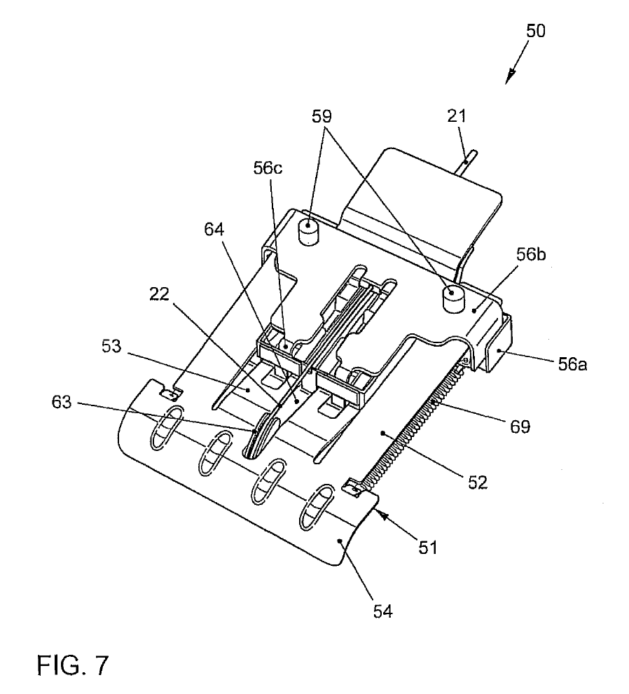

FIG. 7 shows an adjusting device for a side cheek according to a third exemplary embodiment in a perspective view from above.

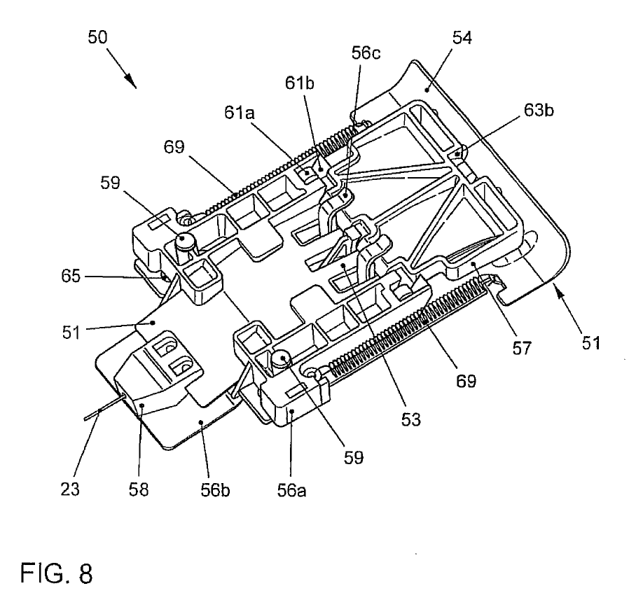

FIG. 8 shows the adjusting device of FIG. 7 in a perspective view from below.

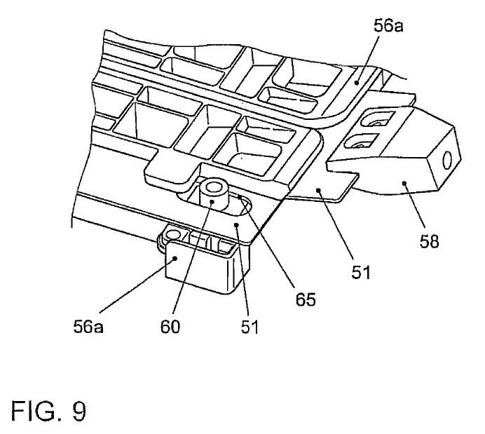

FIG. 9 is a perspective detail view of the adjusting device of FIG. 7.

With reference to FIG. 1, a method according to the invention for adjusting a side cheek of a seat is explained first. FIG. 1 shows a view of a backrest 1 of a seat, for example a motor vehicle seat, from above at different times during the method for adjusting the side cheek. The back of a person 3 sitting on the seat rests against the backrest 1. By actuation of a switch by the person 3, or automatically due to the output of a sensor, the method for adjusting the backrest is initiated. FIG. 1A illustrates schematically a starting position of side cheeks 2 of the backrest 1, in which the side cheeks 2 protrude only by a relatively low height from the backrest. With the aid of an adjusting device explained in detail below, the side cheeks 2 are displaced, in the method according to the invention, according to a curve which, starting from the starting position of FIG. 1A, first has a substantially rectilinear section running substantially perpendicular to the surface of the backrest 1, and then has a curved section bent in the direction of the seat interior (FIGS. 1B and 1C). By this method, as can be seen from FIG. 1C, the person 3 is so to speak embraced from behind by the side cheeks so as to have improved lateral support on the seat.

The same effect can also be achieved with a slightly modified method in which the side cheeks are adjusted along a curved section, for example a circular segment section, of which the section adjacent to the backrest runs substantially perpendicular to the latter.

In the following, different exemplary embodiments of an adjusting device according to the invention for a side cheek, by which the method illustrated in FIG. 1 can be carried out, are explained with reference to FIGS. 2-9.

FIG. 2 shows a first exemplary embodiment of an adjusting device 10 according to the invention, which comprises a bending element 11, in the example illustrated a plate made of resilient steel, and a holder 16 for holding the bending element. The bending element 11 can be produced from any suitable material with shape memory, for example from resilient steel or a plastic with shape memory.

At an end illustrated at the top in FIG. 2, the plate 11 has a widened section 13 to which an extension 14, for example made of plastic, is attached. Via the extension 14, the plate 11 is, in use, coupled to the side cheek of the seat, which may, for example, be achieved by the extension 14 pressing against the foam of the side cheek. A central section 12 of the plate 11 has a plurality of slot-shaped openings to facilitate bending of the plate 11. A section of the plate 11 illustrated at the bottom in FIG. 2 is displaceably mounted on the holder 16. Lateral sections 15 of the plate 11, which assist in biasing the plate towards a rest configuration with little curvature, can be attached likewise displaceably to the holder 16 by means of slot-shaped openings and bolts 17, the lower ends, in FIG. 2, of the slot-shaped openings of the lateral sections 15 together with the bolts 17 serving as a stop which prevents further displacement of the plate 11 relative to the holder 16 as soon as the bolts 17 touch the lower ends of the slot-shaped openings of the lateral sections 15. The lateral sections 15 may however also be immovably attached to the holder 16 by means of the bolts 17, so that only the central part 12 of the plate 11 is displaceable relative to the holder 16, the path curve described by the section 13 of the plate 11 being determined by the combined bending and displacement of the central part 12.

The curvature of the plate 11 is altered by means of a Bowden control 21. A Bowden control receptacle 18 receives one end of a sheath of the Bowden control 21. The Bowden control receptacle 18 is coupled to the lower section, in FIG. 2, of the central part 12 of the plate. One end of a cable 22 of the Bowden control is coupled to the central part 12 of the plate, a fastening 23 for the end of the Bowden control cable being arranged preferably at a section of the central part 12 in the vicinity of the widened section 13. The Bowden control receptacle 18 coupled to the plate 11 simultaneously fulfils the function of a slide which, in the event of a shortening of a free length of the cable 22 of the Bowden control 21, pushes the central part 12 of the plate in FIG. 2 upwards. In the exemplary embodiment illustrated, on the holder 16, there is provided a recess into which the Bowden control receptacle 18 travels on actuation of the adjusting device.

The free length of the cable 22 is adjusted by means of a suitable actuator 6, for example an electric motor having a cable pulley coupled thereto, to which the lower end of the cable 22 in FIG. 2 is fastened. In FIG. 2 the actuator 6 is controlled by control means 5 in dependence on an output signal of a sensor 4. The sensor 4 is, for example, a suitable sensor for detecting the opening of a vehicle door or the actuation of an ignition, or an acceleration sensor which detects forces acting laterally on the seat.

FIG. 3 shows schematically the operation of the adjusting device of FIG. 2. FIG. 3A shows a rest configuration, in which the plate 11 is substantially flat. In the event of a shortening of the free length of the cable 22 of the Bowden control, the Bowden control receptacle 18 coupled to the plate 11 moves upwards in FIG. 3, as illustrated schematically by an arrow. Simultaneously, the plate 11 is bent by the shortening of the free length of the cable 22, as likewise illustrated by an arrow, and reaches the configuration of FIG. 3B, in which the plate has a finite curvature. The resulting movement of the upper end 13 of the plate 11 along a curved path curve is transmitted, via the extension 14, to the side cheek of the seat, which side cheek thus likewise moves along a correspondingly curved path curve.

With reference to FIGS. 4-6, a second exemplary embodiment of an adjusting device 30 according to the invention will now be explained. The adjusting device 30 comprises a bending element 31, the curvature of which can be altered by exerting a force, and supporting means for the bending element. The bending element 31 may, as illustrated in the figure, again be a plate made of resilient steel, but can also be produced from any other suitable material having a shape memory, for example from a plastic material having a shape memory. The plate 31 has, at an end illustrated at the top in FIG. 4, a widened section 34 which in use is coupled to the side cheek in order to adjust the latter. A central slot-shaped opening 44 in the plate 31 serves as a leadthrough for the cable 22 of the Bowden control 21 and, in addition, facilitates bending of the plate 31. Further slot-shaped openings, as shown for example in FIG. 2, may also be provided in the exemplary embodiment of FIG. 4.

The holder for the plate 31 is designed in two parts in this exemplary embodiment and comprises a base section 36 and pivoting section 37 which is pivotably mounted on the base section 36 by means of a joint 41. Holding clips 46, 48 projecting from the base section 36, engage laterally over a section of the plate 31 in order to secure the latter to the base section 36 of the holder. While in the exemplary embodiment illustrated in FIG. 4 four holding clips are illustrated, the number thereof can be varied as long as it is ensured that the plate 31 is securely held by the holder. The holding clips are configured in such a way that the plate 31 remains displaceable relative to the base section 36 and the pivoting section 37. In order to guide the plate 31 on displacement relative to the holder, guide pins 47 projecting from the holding clips 46 engage in slot-shaped guide openings 45 formed in the plate 31.

A Bowden control receptacle 38 is fixedly coupled to one end, illustrated at the bottom in FIG. 4, of the plate 31 and serves to attach a sheath of the Bowden control 21. In contrast to the exemplary embodiment illustrated in FIG. 2, in the exemplary embodiment illustrated in FIG. 4 one end of the cable 22 of the Bowden control is not directly fastened to the plate 31, but to a projection 43, projecting through the slot-shaped opening 44, of the pivoting section 37. Thus, force no longer is exerted on the plate 31 by the cable end of the Bowden control, rather the force exerted by the cable end of the Bowden control is transmitted via the pivoting section 37 to the plate 31 in order to alter its curvature, as will be described in more detail below.

As can best be seen in the perspective view of FIG. 5, the plate 31 is substantially flat or has only a small curvature in the rest configuration illustrated. The plate 31—or, more generally, the bending element of the adjusting device—is configured in such a way that it is biased towards the rest configuration, in which it has little curvature. To increase the restoring force towards the rest configuration, helical springs 49 are provided in the exemplary embodiment of FIG. 4-6, one end of which springs is attached to the widened section 34 of the plate 31, while their other end is fastened to the base section 36 of the holder. The number and spring constants of the helical springs 49 is suitably chosen in dependence on the elastic properties of the plate 31 in order to ensure a sufficient restoring force for the plate 31 to its rest configuration with little curvature.

The operation of the adjusting device illustrated in FIGS. 4 and 5 is now explained with the aid of FIG. 6. FIG. 6A-C shows the adjusting device in a cross-sectional view along the line VI-VI in FIG. 5 during different phases of operation. The Bowden control receptacle 38, the cable 22 of the Bowden control and the projection 43, serving to fasten the cable, of the pivoting section 37 are likewise illustrated by dashed lines for better understanding. In the starting position illustrated in FIG. 6A, the plate 31 is in the rest configuration, in which it is substantially flat, the guide pin 47 bearing against a right-hand end of the guide opening 45 in FIG. 6A, or being situated in the vicinity of this end. If, starting from this starting position, a free length of the cable 22 of the Bowden control is shortened, the Bowden control receptacle 38 connected to the plate 31 exerts on the plate 31a force directed towards the right, so that the plate 31 is displaced towards the right relative to the base section 36 and the pivoting section 37 of the holder, the length of the displacement distance being determined substantially by the length of the guide opening 45 in the plate 31. As soon as the plate 31 has reached the position illustrated in FIG. 6B relative to the holder, in which the guide pin 47 touches the left-hand end of the guide opening 45, the plate 31 cannot be displaced further towards the right. A force which is further exerted on the cable 22 of the Bowden control is transmitted via the projection 43 to the pivoting section 37, which pivots in the direction of the plate 31 under the action of this force. During this pivoting movement relative to the base section 36, the pivoting section 37 contacts the plate 31 and bends the latter into a configuration having a greater curvature, as illustrated schematically in FIG. 6C. The section 34 of the plate 31 which is coupled to the side cheek moves, during the movement sequence illustrated in FIG. 6, along a path curve which runs first substantially rectilinearly and, as soon as the pivoting section 37 is pivoted relative to the base section 36, is curved. The movement along this path curve is transmitted correspondingly to the side cheek, so that with the aid of the adjusting device the method illustrated schematically in FIG. 1 for adjusting a side cheek can be carried out.

It should be noted that, while in FIG. 6 the operation of the adjusting device is shown such that the pivoting section 37 starts to pivot relative to the base section 36 only when the displacement of the plate 31 has ended, the displacement and the bending of the plate 31 can also take place at least partly simultaneously, if the adjusting device is configured in such a way that the pivoting section 37 starts to pivot relative to the base section 36 already when the plate 31 has been displaced by a certain distance relative to the base section 36.

FIGS. 7-9 show a third exemplary embodiment of an adjusting device according to the invention which is similar to the second exemplary embodiment described with reference to FIGS. 4-6. A bending element 51, which in the example illustrated is again made of resilient steel, has a widened section 54 which in use is coupled to the side cheek of the seat. Lateral sections 52, which in the rest configuration illustrated in FIG. 7 run substantially in one plane, are separated from central sections 53 of the plate 51 by elongate slot-shaped openings, the central sections also having a finite curvature in the rest configuration in order to facilitate for example bending of the plate in the desired direction.

A holder for the plate 51 comprises a base section 56 and a pivoting section 57 pivotably mounted thereon. In contrast to the exemplary embodiment illustrated in FIG. 4, in FIG. 7 the base section 56 is formed of a first base section 56a and a second base section 56b, on which there are provided U-shaped holding sections 56c which are positioned through openings in the plate 51 and the first base section 56a in order to help to secure the pivoting section 57 to the first base section 56a, as can best be seen in the bottom perspective view of FIG. 8. The second base section 56b is fastened to the first base section 56a by bolts 59 inserted through corresponding leadthroughs 60. As can best be seen in the partial perspective view of FIG. 9, the leadthroughs 60 together with the corresponding guide openings 65 of the plate 51 serve as guide means which guide a movement of the plate on displacement relative to the holder formed by the base section 56 and the pivoting section 57. Helical springs 69, one end of which is attached to the widened section 54 of the plate 51 and the other end of which is attached to the first base section 56a, serve to increase the bias of the plate towards the rest configuration illustrated in FIGS. 7 and 8. The articulated mounting of the pivoting section 57 on the base section 56 is realised by cylindrical extensions 61a projecting from the pivoting section 57 and arranged rotatably in corresponding openings 61b of the first base section 56a.

A Bowden control receptacle 58 is fixedly coupled to the plate 51. One end of the cable 22 of the Bowden control 21 is guided via a projection 63 of the pivoting section 57 which projects through a central opening 64 of the plate 51 and is secured by a fastening 63B to the pivoting section 57.

The operation of the adjusting device illustrated in FIG. 7-9 corresponds to that of the adjusting device according to the second exemplary embodiment as illustrated schematically in FIG. 6.

As can be seen from the above description of different exemplary embodiments of adjusting devices according to the invention, the adjusting devices 10, 30 and 50 illustrated in FIGS. 2-9 serve to realise an adjustment of a side cheek according to a curve as illustrated schematically in FIG. 1. For this purpose, in use a section of the bending element of the adjusting device is coupled to the side cheek of the seat, while the holder is fastened to the backrest frame. In the exemplary embodiments of FIG. 4 and FIG. 7, in which the holder is constructed from a base section and a pivoting section pivotably mounted thereon, the base section is fastened to the backrest frame. The other end, not illustrated in the figures, of the cable of the Bowden control is fastened to a suitable actuator, for example an electric motor with cable roller attached thereto. The actuator can be arranged at any suitable location on or in the seat, for example in the backrest.

While a Bowden control has been used in the exemplary embodiments set out in detail above, the actuating device can be any other suitable device which is able to exert a pulling or pushing force on the bending element in order to bend the latter, for example a toothed rack driven by a pinion.

An actuation of the adjusting devices and thus an adjustment of the side cheeks of the seat can be initiated in various ways. For example, the actuating device can be controlled directly by the person sitting on the seat activating the adjusting device according to the invention by actuating a switch. Alternatively or additionally, the adjusting device can also be controlled by control means, for example a microcomputer, which are coupled to one or more sensors in order to adjust the side cheeks for example depending on whether a person is sitting on the seat, whether an engine of the vehicle is switched on, whether a door of the vehicle is open or whether the side cheeks are already in contact with the person sitting on the seat. In the latter case, in particular pressure sensors can be integrated into the side cheeks, or the position of the side cheeks relative to the person can be monitored by means of a current flowing in the actuating device, for example the current supplied to an electric motor.

Preferably, two adjustable seat cheeks and, accordingly, two adjusting devices according to the invention associated with them are provided on a backrest of the vehicle seat, which devices can be actuated by a single actuating device.

Possible applications of the adjusting device according to the invention are not restricted however to the applications just described, but comprise for example also the so-called active backrest width adjustment, in which the left or right side cheek of a backrest is selectively adjusted depending on the driving behaviour of a vehicle, for example depending on an acceleration acting laterally on the vehicle. In particular, the left or right side cheek can be selectively adjusted by the adjusting device according to the invention while travelling round a bend, in order to provide the person sitting on the seat with improved support against the centrifugal force acting on the person.

The method according to the invention for adjusting side cheeks of a seat and the adjusting device according to the invention for a side cheek are not restricted to an application in which side cheeks are provided on a backrest. Rather, the method according to the invention and the adjusting device according to the invention can also be used in seat cheeks or in headrests of a seat. The present invention can be employed in any desired seats, in particular in vehicle seats, but is not restricted to the latter.

1-22. (canceled)

23. An adjusting device for a side cheek of a seat, comprising
a bending element which is to be coupled to the side cheek and the curvature of which can be reversibly changed by exerting a force on the bending element in order to adjust the side cheek in dependence on the curvature of the bending element,
wherein the bending element is to be coupled to an actuating device for exerting a force on the bending element in order to adjust the curvature of the bending element, and
supporting means for holding the bending element, the bending element being displaceably attached to the supporting means.

24. An adjusting device according to claim 23, wherein the bending element is biased towards a rest configuration in which it has no curvature or little curvature.

25. An adjusting device according to claim 23, wherein the bending element is substantially flat in the rest configuration.

26. An adjusting device according to claim 23, wherein the bending element comprises a plate made of resilient steel or is produced from plastic.

27. An adjusting device according to claim 23, wherein the bending element is to be coupled to the actuating device in such a way that, when a force is exerted on the bending element, the bending element is displaced relative to the supporting means.

28. An adjusting device according to claim 23, further comprising;
a stop means for preventing further displacement of the bending element relative to the supporting means if the bending element is situated in a preset position relative to the supporting means.

29. An adjusting device according to claim 28, wherein the supporting means and the bending element are configured in such a way that the bending element, if it is situated in the preset position, is bent by further exertion of a force.

30. An adjusting device according to claim 23, further comprising;
a guide recess which is provided on the bending element and with which a guide projection provided on the supporting means engages.

31. An adjusting device according to claim 23,
wherein the supporting means comprise a base section and a pivoting section pivotably mounted thereon,
the supporting means being configured in such a way that the pivoting section, when performing a pivoting movement relative to the base section, contacts the bending element in order to transmit a force, acting on the pivoting section, to the bending element.

32. An adjusting device according to claim 31, wherein the actuating device is to be coupled to the pivoting section in order to transmit a force, exerted by the actuating device, to the bending element via the pivoting section.

33. An adjusting device according to claim 23, further comprising;
an actuating device which is coupled to the bending element and serves to exert a force on the bending element.

34. An adjusting device according to claim 33,
wherein the actuating device comprises a Bowden control, and
a sheath of the Bowden control is coupled to the bending element and a cable of the Bowden control is coupled to supporting means provided for supporting the bending element.

35. A seat, comprising;
an adjustable side cheek, and
an adjusting device which is coupled to the adjustable side cheek in order to adjust the latter, the adjusting device comprising
a bending element which is to be coupled to the side cheek and the curvature of which can be reversibly changed by exerting a force on the bending element in order to adjust the side cheek in dependence on the curvature of the bending element,
wherein the bending element is to be coupled to an actuating device for exerting a force on the bending element in order to adjust the curvature of the bending element, and
a supporting means for holding the bending element, the bending element being displaceably attached to the supporting means.

36. A seat according to claim 35,
wherein the seat has a further adjustable side cheek and a further adjusting device which is coupled to the further adjustable side cheek, the side cheek and the further side cheek being arranged symmetrically on the seat.

37. A seat according to claim 35,
wherein the adjustable side cheek is arranged on a backrest of the seat.

38. A seat according to claim 35, further comprising;
an actuating device which is coupled to the adjusting device and serves to exert a force on the bending element in order to adjust the curvature of the bending element.

39. A seat according to claim 38, further comprising;
an acceleration sensor and
a control means which are coupled to the acceleration sensor and the actuating device and serve to control the actuating device in dependence on an output signal of the acceleration sensor.

40. A seat according to claim 35,
wherein the adjusting device is arranged on the seat and configured in such a way that the side cheek is adjusted according to an adjusting curve which, starting from a seat surface of the seat, first comprises a substantially straight section and then a curved section running inwards with respect to the seat.

41. A method for adjusting a side cheek of a seat, in which the side cheek is adjusted according to an adjusting curve which, starting from the seat surface of the seat, first comprises a straight section and then a curved section running inwards with respect to the seat.

42. A method according to claim 41, in which the side cheek is adjusted in dependence on an acceleration acting on a vehicle.

43. A method according to claim 41, wherein the side cheek is adjusted by an adjusting device comprising;
a bending element which is to be coupled to the side cheek and the curvature of which can be reversibly changed by exerting a force on the bending element in order to adjust the side cheek in dependence on the curvature of the bending element,
wherein the bending element is to be coupled to an actuating device for exerting a force on the bending element in order to adjust the curvature of the bending element, and
a supporting means for holding the bending element, the bending element being displaceably attached to the supporting means.
